(19) United States
(12) Patent Application Publication
(10) Pub. No.: US 2025/0307780 A1
(43) Pub. Date: Oct. 2, 2025

(54) SYSTEM AND METHOD FOR AUTOMATED EMPLOYMENT PLACEMENT UTILIZING ARTIFICIAL INTELLIGENCE

(71) Applicant: Calvetta Phair, Miami, FL (US)

(72) Inventor: Calvetta Phair, Miami, FL (US)

(21) Appl. No.: 19/098,274

(22) Filed: Apr. 2, 2025

Related U.S. Application Data
(60) Provisional application No. 63/573,236, filed on Apr. 2, 2024.

(51) Int. Cl. G06Q 10/1053

(52) U.S. Cl. CPC G06Q 10/1053

(57) ABSTRACT

The present invention generally relates to systems, methods, and machine-readable media for facilitating online employment placement. Specifically, techniques are disclosed to facilitate online and mobile employment placing, leveraging various aspects of artificial intelligence, machine learning and virtual reality systems.

### RELATED APPLICATIONS

This application claims the benefit of priority to U.S. Provisional Application No. 63/573,236, filed Apr. 2, 2024, the entire contents of which are incorporate herein by reference.

### FIELD OF THE INVENTION

The present invention generally relates to systems, methods, and machine-readable media for facilitating online employment placement. Specifically, techniques are disclosed to facilitate online and mobile employment placing, leveraging various aspects of artificial intelligence, machine learning and virtual reality systems.

### BRIEF DESCRIPTION OF THE DRAWINGS

FIG. 1 illustrates a schematic overview of a computing device, in accordance with an embodiment of the present invention; and

FIG. 2 illustrates a network schematic of a system, in accordance with an embodiment of the present invention.

### DETAILED SPECIFICATION

The present invention generally relates to systems, methods, and machine-readable media for facilitating online employment placement. Specifically, techniques are disclosed to facilitate online and mobile employment placing, leveraging various aspects of artificial intelligence, machine learning and virtual reality systems. According to one or more embodiments, facilitating employment placements may allow companies and potential employees to match and hire more conveniently, more inexpensively, and more easily optimized for an ever-changing workforce.

Embodiments of the present invention address the need for a streamlined, efficient processes for employment placement, significantly improving upon traditional methods by incorporating digital technologies and analysis of social media and other data provider systems. Embodiments of the present invention are further configured to facilitate quicker, more effective matches between job seekers, referrers, and companies, thereby reducing the time and resources spent on the recruitment process.

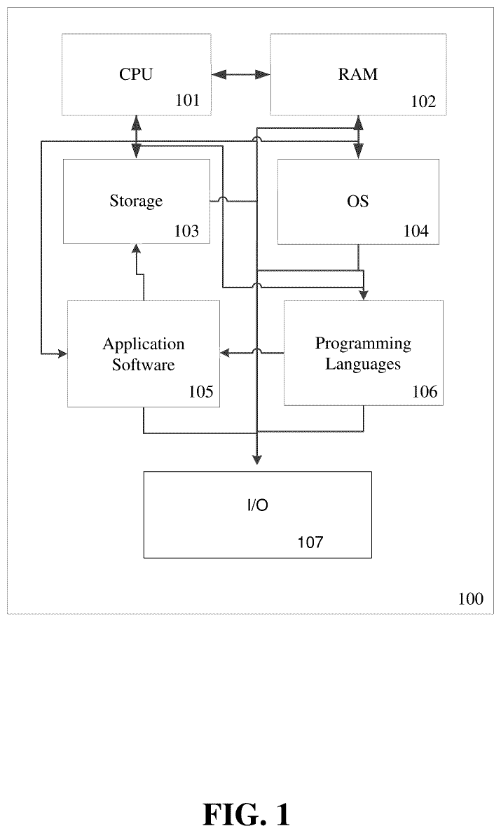

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

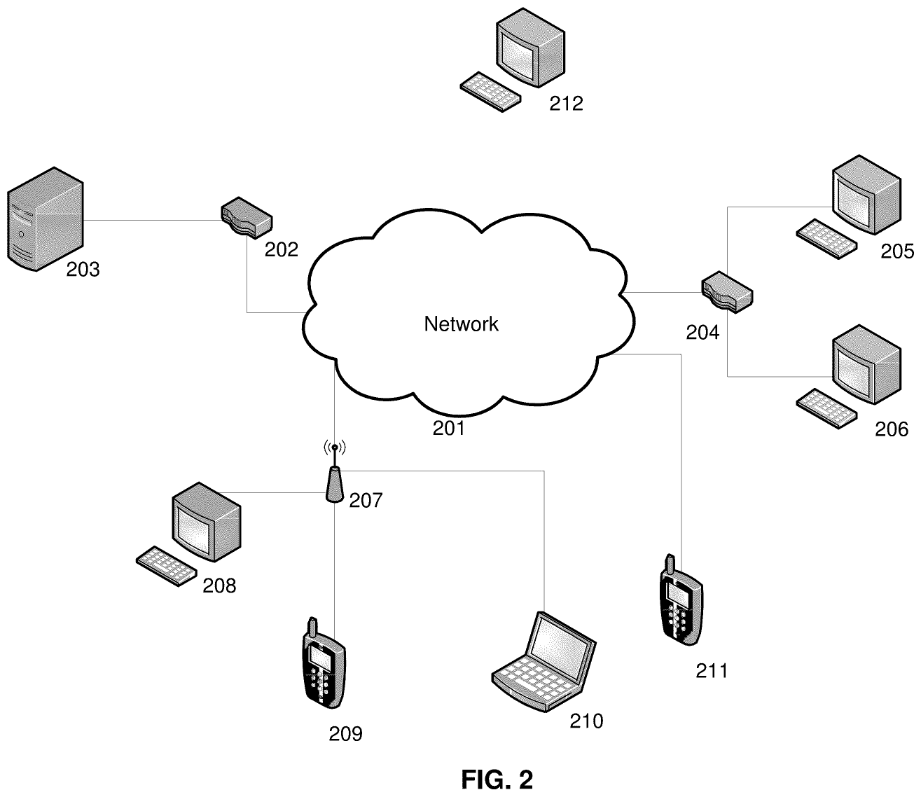

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

In certain embodiments, the system comprises one or more key components, including, but not limited to, a job seeker interface, a referrer interface, and a company interface. Each interface may be tailored to meet one or more specific needs and actions of its users, from profile creation to job application, and includes features such as integration with virtual reality capabilities for job interviews and tours, as well as social media analytics for identifying potential job candidates.

In preferred embodiments, job seekers can create detailed profiles, including submission of one or more of a short video introduction, resume uploads, and, optionally, a segment of personal information, such as music expression (e.g., short audio clip from a music platform such as Spotify, YouTube, Apple Music or other platform), or other data points that an employer may find useful in their candidate selection process (e.g., past articles written by candidate, public awards, special talents). Certain embodiments of the present invention may utilize various AI methodologies to better predict and suggest job openings based on the job seeker's skills, experience, and interests, potentially pulling data from social media and public records to enhance profile completeness and accuracy. In order to do this, embodiments of the present invention may leverage artificial intelligence or machine learning techniques and systems, such as, but not limited to, machine learning models trained on various amounts of test and training data, neural networks (e.g., Artificial Neural Networks (ANN), Convolution Neural Networks (CNN), Recurrent Neural Networks (RNN)), deep learning models and deep-learning-based generative models (e.g., generative adversarial networks (GANs)). One of ordinary skill in the art would appreciate that there are numerous types of ML and AI systems that could be used for the purposes detailed herein, and embodiments of the present invention are contemplated for use with any such ML or AI system.

In preferred embodiments of the present invention, Individuals or entities acting as referrers can create profiles and are notified of job openings that match the profiles of job seekers they are connected with. Referrers have the ability to alert both registered and unregistered potential candidates about job opportunities, facilitating a broader search for suitable applicants.

According to embodiments of the present invention, companies may post job openings on the platform, which are then disseminated to job seekers and referrers. The system may be configured to offer companies tools for virtual reality (VR) interviews, immediate communication with candidates, and automated notifications when a candidate applies for a position. Companies benefit from a streamlined billing process for referrals and access to a wide network of potential candidates.

In certain embodiments of the present invention, the system provides capability for companies to conduct interviews with candidates using VR technology. This allows for virtual office tours, work environment previews, and more immersive assessment experiences, providing both parties with a better understanding of the potential workplace fit. In other embodiments, various embodiments may use other VR technology methods and similar concepts, such as use of augmented reality (AR) or mixed reality (MR) technologies. One of ordinary skill in the art would appreciate that there are numerous ways these systems could be implemented for these purposes, and all such implementations are contemplated for use with embodiments of the present invention.

According to certain embodiments of the present invention, the system may be configured to introduce a marketplace where recruiters can showcase their services and expertise to companies. This feature operates similarly to online freelance marketplaces but is focused specifically on recruitment services, offering tools for background checks, payroll management, and more.

According to certain preferred embodiments of the present invention, the system may leverage AI/ML components to analyze one or more data sources, including, but limited to, social media, third party data sources, and public records to identify potential job candidates, expanding the reach beyond the immediate user base of the platform. This approach not only enhances the pool of candidates but also provides richer data for matching purposes. These components may also be used to engage with potential candidates to see if they are interested in particular job openings and joining the platform for such purposes.

According to certain embodiments of the present invention, when a company accesses or downloads a candidate's profile or schedules an interview, the referrer is immediately compensated, with the platform facilitating the transaction. This feature incentivizes the referral process, ensuring active participation from the community and prevents disintermediation from the platform by employers and candidates.

According to still further embodiments of the present invention, the system may also be configured to offer customized solutions for government agencies and small businesses, including discounted rates for federal buyers and branding options for small enterprises. Certain components of the system, such as an AI or ML configured component, can be utilized to automatically identify potential benefits and programs that would apply to specific positions and roles, whether at small businesses, government, or other employers.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for facilitating online employment placement.

2. A system for facilitating online employment placement.

3. The invention as described herein.
